(19) United States
(12) Patent Application Publication
(10) Pub. No.: US 2024/0046662 A1
(43) Pub. Date: Feb. 8, 2024

(54) DETECTING DEVICE, AND LOADING RATIO ESTIMATING SYSTEM

(71) Applicant: ISUZU MOTORS LIMITED, Yokohama-shi (JP)

(72) Inventors: Maya MATSUSHITA, Fujisawa-shi (JP); Tomoaki SHIMOZAWA, Fujisawa-shi (JP); Yuka MIZUSHI, Fujisawa-shi (JP)

(21) Appl. No.: 18/280,416

(22) PCT Filed: Mar. 16, 2022
(86) PCT No.: PCT/JP2022/011999

§ 371 Date: Sep. 5, 2023

(30) Foreign Application Priority Data
Mar. 24, 2021 (JP) 2021-049744

(51) Int. Cl. G06V 20/59; G06V 10/56

(52) U.S. Cl. CPC G06V 20/59; G06V 10/56

(57) ABSTRACT

Provided are a detecting device and a loading ratio estimating system which are highly durable, with which it is possible for an open or closed state of a luggage compartment door to be stably detected, and with which a decrease in design freedom in the vicinity of the luggage compartment door can be suppressed. This detecting device includes: a calculating unit which acquires a color image of the interior of a luggage compartment provided with a door that is free to open and close, and which calculates a determination value on the basis of color information relating to a plurality of pixels included in the color image; and a determining unit which determines that the door is open if the determination value is greater than a predetermined threshold, and determines that the door is closed if the determination value is at most equal to the threshold.

### TECHNICAL FIELD

The present disclosure relates to a sensing apparatus and a loading rate estimation system that are used in a vehicle equipped with a cargo compartment.

### BACKGROUND ART

Conventionally, a vehicle equipped with a cargo compartment into which cargo is loaded has been known. Additionally, a sensor has been known which senses an open/closed state of a door provided on an opening portion of the cargo compartment (hereinafter also referred to as a cargo-compartment door) (e.g., see Patent Literatures (hereinafter each referred to as “PTL”) 1 and 2).

### CITATION LIST

### Patent Literature

### PTL 1

20 Japanese Patent Application Laid-Open No. H04-292772

### PTL 2

Japanese Patent Application Laid-Open No. H07-331960

### SUMMARY OF INVENTION

### Technical Problem

The above-described sensor, however, is provided limited to a position susceptible to impact when the cargo-compartment door is opened and closed (e.g., around cargo-compartment door), which may lead to deteriorations in durability and stability of the sensor itself and a wire connected to the sensor. Further, providing the sensor around the cargo-compartment door also reduces the degree of freedom in design around the cargo-compartment door.

An object of one aspect of the present disclosure is to provide a sensing apparatus and a loading rate estimation system each capable of durably and stably sensing an open/closed state of a cargo-compartment door and suppressing reduction in the degree of freedom in design around the cargo-compartment door.

### Solution to Problem

A sensing apparatus according to an aspect of the present disclosure includes: a calculation section that acquires a color image of an inside of a cargo compartment provided with a door and calculates a determination value based on color information of a plurality of pixels included in the color image, the door being openable and closable; and a determination section that determines that the door is in an open state when the determination value is greater than a threshold that is previously determined, and determines that the door is in a closed state when the determination value is less than or equal to the threshold.

A loading rate estimation system according to an aspect of the present disclosure includes: a sensing apparatus including, a calculation section that acquires a color image of an inside of a cargo compartment provided with a door and calculates a determination value based on color information of a plurality of pixels included in the color image, the door being openable and closable, and a determination section that determines that the door is in an open state when the determination value is greater than a threshold that is previously determined, and determines that the door is in a closed state when the determination value is less than or equal to the threshold; and a loading rate estimation apparatus that estimates a loading rate of a vehicle equipped with the cargo compartment when the determination section determines that the door is in the closed state.

### Advantageous Effects of Invention

According to the present disclosure, it is possible to durably and stably sense an open/closed state of a cargo-compartment door and suppress reduction in the degree of freedom in design around the cargo-compartment door.

### BRIEF DESCRIPTION OF DRAWINGS

FIG. 1 schematically illustrates a vehicle and an inside of a cargo compartment according to an embodiment of the present disclosure;

FIG. 2 is a block diagram illustrating an exemplary configuration of a loading rate estimation system according to the embodiment of the present disclosure;

FIG. 3 illustrates an exemplary cargo-compartment inside image according to the embodiment of the present disclosure;

FIG. 4 schematically illustrates an exemplary configuration of a determination area according to the embodiment of the present disclosure; and

FIG. 5 is a flowchart describing an exemplary operation of a sensing apparatus according to the embodiment of the present disclosure.

### DESCRIPTION OF EMBODIMENTS

Hereinafter, an embodiment of the present disclosure will be described in detail with reference to the drawings. Note that, in all the drawings, an element the same as a precedent element is given the same reference numeral, and the description thereof may be omitted.

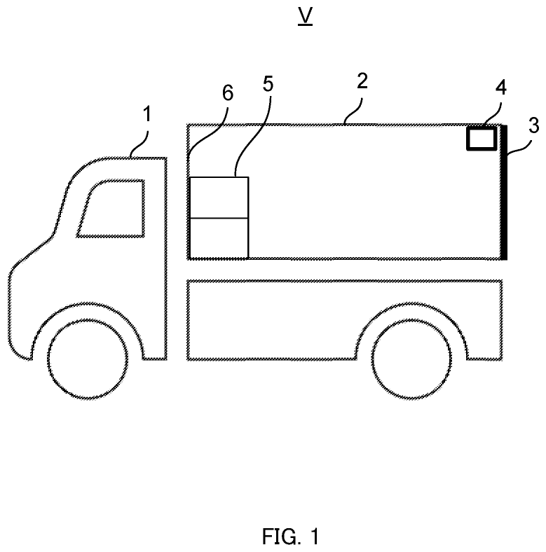

First, vehicle V of the present embodiment will be described with reference to FIG. 1. FIG. 1 is a schematic side view of vehicle V and an inside of a cargo compartment.

As illustrated in FIG. 1, vehicle V is a truck equipped with cab 1 and cargo compartment 2. Incidentally, vehicle V is not limited to a truck and may be another type of vehicle.

Cargo compartment 2 is box-shaped and has an opening portion (not illustrated; the same applies hereinafter) on a rear side surface, for example. Loading and unloading of cargo are carried out through the opening portion. FIG. 1 illustrates, as an example, a state where a plurality of cargoes 5 are placed in the vicinity of inner wall surface 6 of cargo compartment 2 (specifically, inner wall surface of side wall located in the front of cargo compartment 2).

At the rear of cargo compartment 2, door 3, which is openable and closable, is provided such that the door corresponds to a position of the opening portion. An example of door 3 includes but not limited to a door that opens by rotating, in a left and right direction from a center of the opening portion, about the axes, which are left and right edges of the opening portion (what is called hinged-double type door).

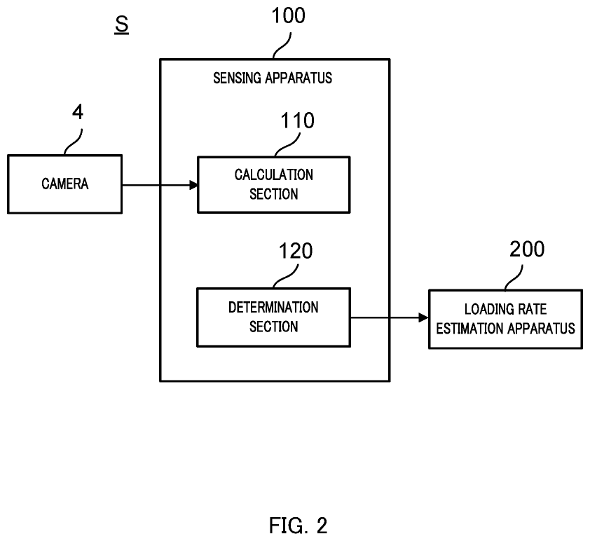

At the rear of cargo compartment 2, camera 4 is provided which can capture an inside of cargo compartment 2 (except for door 3 and opening portion). Camera 4 transmits an image of the inside of cargo compartment 2, which is obtained by capturing (hereinafter referred to as a cargo-compartment inside image), to sensing apparatus 100 to be described later (see FIG. 2). Incidentally, FIG. 1 illustrates camera 4 provided on the ceiling of cargo compartment 2, but an installation position of camera 4 is not limited to this.

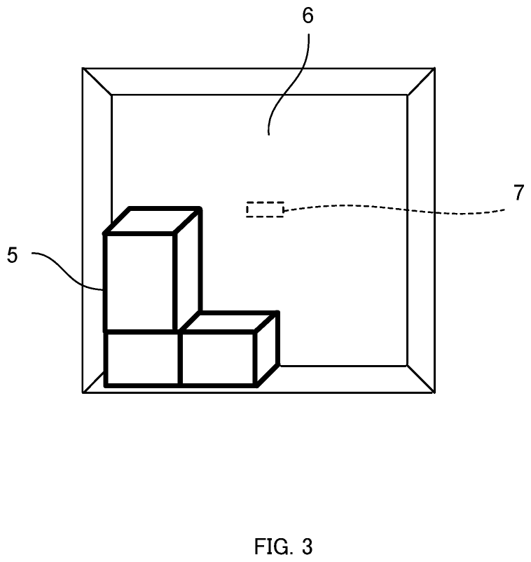

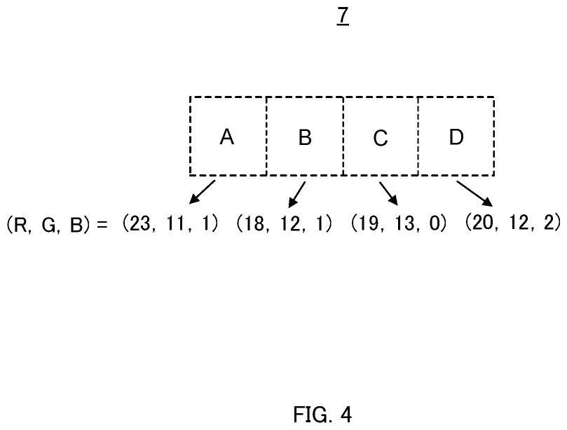

The cargo-compartment inside image is a color image having color information for each pixel that composes the image. In the present embodiment, as an example, a case will be described where the color image is an RGB image having elements of Red (R), Green (G), and Blue (B) and the color information is an RGB value. The cargo-compartment inside image will be described later in detail with reference to FIGS. 3 and 4.

Besides, camera 4 is integrally configured with a depth sensor (not illustrated). The depth sensor is a sensor capable of measuring a distance from itself to a person and/or an object in two dimension. A sensing result of the depth sensor is output to loading rate estimation apparatus 100 to be described later (see FIG. 2).

Although not illustrated in FIG. 1, sensing apparatus 100 and loading rate estimation apparatus 200 to be described later (see FIG. 2) are further mounted on vehicle V.

Vehicle V has been described, thus far.

Next, loading rate estimation system S of the present embodiment will be described with reference to FIG. 2. FIG. 2 is a block diagram illustrating an exemplary configuration of loading rate estimation system S.

Loading rate estimation system S illustrated in FIG. 2 is mounted on vehicle V illustrated in FIG. 1.

Although not illustrated, sensing apparatus 100 and loading rate estimation apparatus 200 each include, as hardware, a Central Processing Unit (CPU), a Read Only Memory (ROM) that stores computer programs therein, and a Random Access Memory (RAM), for example. The functions of the apparatuses described below are realized by the CPU executing a computer program read from the ROM in the RAM. For example, sensing apparatus 100 and loading rate estimation apparatus 200 may be realized by an Electronic Control Unit (ECU).

Sensing apparatus 100 is an apparatus that calculates a determination value (see below for details), based on a cargo-compartment inside image acquired from camera 4, and then determines whether door 3 is in an open state or a closed state, by comparing the determination value with a threshold.

As illustrated in FIG. 2, sensing apparatus 100 includes calculation section 110 and determination section 120.

Calculation section 110 acquires a cargo-compartment inside image from camera 4.

Here, an example of the cargo-compartment inside image captured with camera 4 will be described with reference to FIG. 3. FIG. 3 illustrates an exemplary cargo-compartment inside image.

As illustrated in FIG. 3, the cargo-compartment inside image includes, for example, images of cargoes 5 and inner wall surface 6 illustrated in FIG. 1.

In addition, as illustrated in FIG. 3, determination area 7 that includes a plurality of pixels is set for the cargo-compartment inside image. As an example herein, suppose that determination area 7 is set to a central portion of the cargo-compartment inside image (more specifically, image of central portion of inner wall surface 6).

The setting (including modification) of determination area 7 is executed by a computer program in advance, for example. For the setting, considerations are given of usage and required accuracy for a user (e.g., occupant of vehicle V, operator carrying out loading or unloading, or the like).

The exemplary cargo-compartment inside image has been described above.

Next, determination area 7 illustrated in FIG. 3 will be described with reference to FIG. 4. FIG. 4 schematically illustrates an exemplary configuration of determination area 7.

As illustrated in FIG. 4, determination area 7 includes pixel A, pixel B, pixel C, and pixel D.

Further, as illustrated in FIG. 4, pixels A to D each have an RGB value. The RGB value of pixel A is (23, 11, 1), for example. The RGB value of pixel B is (18, 12, 1), for example. The RGB value of pixel C is (19, 13, 0), for example. The RGB value of pixel D is (20, 12, 2), for example.

Determination area 7 has been described above.

Hereinafter, let us return to the description of FIG. 2.

Calculation section 110 recognizes determination area 7 in the cargo-compartment inside image illustrated in FIG. 3 and then calculates a determination value based on the respective RGB values of pixels A to D included in determination area 7.

The determination value is a value to be compared with a predetermined threshold, and is, for example, a statistical amount (such as mean, variance, or total) in a plurality of pixels.

By way of example, the determination value may be mean values, respectively, of R-values, G-values, and B-values in pixels A to D. Alternatively, for example, the determination value may be the mean value of RGB total values (total values of R-values, G-values, and B-values) in pixels A to D. Alternatively, for example, the determination value may be central values, respectively, of R-values, G-values, and B-values in pixels A to D. Yet alternatively, for example, the determination value may be total values, respectively, of R-values, G-values, and B-values in pixels A to D.

The threshold is a value at which door 3 can be regarded to be in the closed state and is set based on results of previously conducted experiments, simulations, or the like.

Determination section 120 compares a determination value calculated by calculation section 110 with the predetermined threshold.

When the determination value is greater than the threshold, determination section 120 determines that door 3 is in the open state.

When the determination value is less than or equal to the threshold, determination section 120 determines that door 3 is in the closed state. Further, in this case, determination section 120 transmits (outputs), to loading rate estimation apparatus 200, determination-result information indicating that door 3 is in the closed state.

Loading rate estimation apparatus 200 is an apparatus that estimates a loading rate based on a sensing result of the depth sensor, when receiving, from sensing apparatus 100 (specifically, determination section 120), the determination-result information indicating that door 3 is in the closed state. The loading rate is a ratio of a volume of cargo 5 placed in cargo compartment 2 to the maximum loading volume of vehicle V.

A publicly known technique can be applied to an estimation method of the loading rate performed in loading rate estimation apparatus 200. Examples of the publicly known techniques include but are not limited to, for example, methods disclosed in Japanese Patent Application Laid Open No. 2003-35527, <URL:https://creanovo.de/portfolio/wabco-cargocam/>, <URL:https://www.ncos.co.jp/news/news_210113.html>, and the like.

The configurations of loading rate estimation system S and sensing apparatus 100 have been each described, thus far.

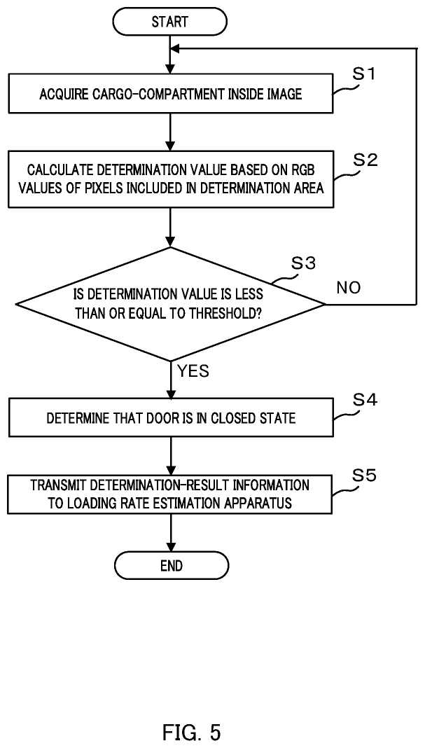

Next, an operation of sensing apparatus 100 will be described with reference to FIG. 5. FIG. 5 is a flowchart describing an exemplary operation of sensing apparatus 100. The flow of FIG. 5 is started at the time of stop of vehicle V and is repeatedly performed during the stop of vehicle V, for example.

First, calculation section 110 acquires a cargo-compartment inside image from camera 4 (step S1).

Calculation section 110 then calculates a determination value based on an RGB value of each of a plurality of pixels (e.g., pixels A to D illustrated in FIG. 4) that is included in determination area 7 in the cargo-compartment inside image (e.g., cargo-compartment inside image illustrated in FIG. 3) (step S2). Note that the determination value may be any of the above-mentioned aspects.

Next, determination section 120 determines whether the calculated determination value is less than or equal to a threshold (step S3).

When the determination value is not less than or equal to the threshold (step S3: NO), the flow returns to step S1.

When the determination value is less than or equal to the threshold (step S3: YES), determination section 120 determines that door 3 is in a closed state (step S4).

Determination section 120 then transmits, to loading rate estimation apparatus 200, determination-result information indicating that door 3 is in the closed state (step S5). Loading rate estimation apparatus 200, which has received this determination-result information, performs estimation of a loading rate.

The operation of sensing apparatus 100 has been described, thus far.

As described in detail above, sensing apparatus 100 of the present embodiment is characterized by acquiring a colored cargo-compartment inside image, calculating a determination value, based on color information (e.g., RGB values) of a plurality of pixels included in the cargo-compartment inside image, and thereby determining that door 3 is in an open state when the determination value is greater than a threshold and that door 3 is in a closed state when the determination value is less than or equal to the threshold.

Thus, sensing apparatus 100 of the present embodiment is capable of calculating an open/closed state of door 3 without using a sensor installed around a cargo-compartment door, as in PTLs 1 and 2, for example. Hence, it is possible to durably and stably sense an open/closed state of a cargo-compartment door and suppress reduction in the degree of freedom in design around the cargo-compartment door.

Meanwhile, loading rate estimation system S of the present embodiment is characterized in that loading rate estimation apparatus 200 performs estimation of a loading rate when sensing apparatus 100 determines that door 3 is in a closed state.

When a loading rate is estimated while an operator is in cargo compartment 2, the operator is treated in the same manner as cargo 5, which deteriorates the estimation accuracy of the loading rate. In loading rate estimation system S of the present embodiment, a loading rate is estimated when door 3 is in a closed state (i.e., when operator is not in cargo compartment 2), thus improving the estimation accuracy.

Further, in loading rate estimation system S of the present embodiment, camera 4 and the depth sensor are integrally provided with each other, which allows a simple configuration.

The present disclosure is not limited to the description of the above embodiment, and various modifications can be made without departure from the spirit of the disclosure. In the following, variations will be described.

[Variation 1]

In the embodiment, a case has been described as an example where sensing apparatus 100 and loading rate estimation apparatus 200 are provided separately, but the present disclosure is not limited to this case.

In one example, sensing apparatus 100 may have a function of loading rate estimation apparatus 200 (may be referred to as a loading rate estimation section). In this case, camera 4 and sensing apparatus 100 may be referred to as a loading rate estimation system in combination.

Further, in the embodiment, a case has been described as an example where sensing apparatus 100 and loading rate estimation apparatus 200 are mounted on vehicle V, but the present disclosure is not limited to this case. In one example, sensing apparatus 100 and loading rate estimation apparatus 200 may be realized by a computer (e.g., server and the like) installed outside vehicle V. In this case, for example, a communication apparatus mounted on vehicle V (not illustrated) may transmit, to the computer, a cargo-compartment inside image or determination-result information.

[Variation 2]

In the embodiment, as illustrated in FIG. 3, a case has been described as an example where only one determination area 7, which is rectangular-shaped, is set to a central portion of the cargo-compartment inside image, but the position, shape, size, and number of determination areas 7 are not limited to the illustration of FIG. 3. Determination area 7 is preferably, however, an area where contrast tends to appear due to opening and closing of door 3 in the cargo-compartment inside image.

In one example, determination area 7 may be the entire area of cargo-compartment inside image.

Alternatively, for example, determination area 7 may be an area corresponding to a portion of the inside of cargo compartment 2 that is first exposed to light when door 3 opens. In this case, door 3 can be determined as in the open state as long as door 3 opens even slightly, thus further improving a determination speed.

[Variation 3]

In the embodiment, determination section 120 may transmit determination-result information indicating that door 3 is in an open state or a closed state to an apparatus other than loading rate estimation apparatus 200.

In one example, determination section 120 may transmit determination-result information indicating either an open state or a closed state of door 3 to a broadcast apparatus provided in cab 1 (not illustrated; e.g., display, speaker, and the like). In this case, the broadcast apparatus performs image displaying and/or sound outputting that indicate(s) either an open state or a closed state. This allows a user (e.g., occupant of vehicle V, operator carrying out loading or unloading, or the like) to recognize an open/closed state of door 3.

The variations have been each described, thus far. Note that the above variations may be combined with each other as appropriate.

This application is based on Japanese Patent No. 2021-049744 filed on Mar. 24, 2021, the disclosure of which including the specification, drawings and abstract is incorporated herein by reference in its entirety.

### INDUSTRIAL APPLICABILITY

A sensing apparatus and a loading rate estimation system of the present disclosure are useful for a vehicle equipped with a cargo compartment.

### REFERENCE SIGNS LIST

1 Cab
2 Cargo compartment
3 Door
4 Camera
5 Cargo
6 Inner wall surface (of front side wall)
100 Sensing apparatus
110 Calculation section
120 Determination section
200 Loading rate estimation apparatus
S Loading rate estimation system
V Vehicle

1. A sensing apparatus, comprising:
a calculation section that acquires a color image of an inside of a cargo compartment provided with a door and calculates a determination value based on color information of a plurality of pixels included in the color image, the door being openable and closable; and
a determination section that determines that the door is in an open state when the determination value is greater than a threshold that is previously determined, and determines that the door is in a closed state when the determination value is less than or equal to the threshold.

2. The sensing apparatus according to claim 1, wherein the calculation section
recognizes a determination area that is set to a certain portion of the color image, and
calculates the determination value based on the color information on the plurality of pixels included in the determination area.

3. The sensing apparatus according to claim 1, wherein the determination value is a statistical amount based on an RGB value serving as the color information.

4. The sensing apparatus according to claim 1, further comprising a loading rate estimation section that estimates a loading rate of a vehicle equipped with the cargo compartment when the door is determined as in the closed state.

5. The sensing apparatus according to claim 1, wherein, when determining that the door is in the closed state, the determination section transmits information indicating that the door is in the closed state to a loading rate estimation apparatus that estimates a loading rate of a vehicle equipped with the cargo compartment.

6. The sensing apparatus according to claim 4, wherein:
the color image is an image captured with a camera provided inside the cargo compartment, and
the loading rate is estimated based on a sensing result of a depth sensor integrated with the camera.

7. A loading rate estimation system, comprising:
a sensing apparatus including,
a calculation section that acquires a color image of an inside of a cargo compartment provided with a door and calculates a determination value based on color information of a plurality of pixels included in the color image, the door being openable and closable, and
a determination section that determines that the door is in an open state when the determination value is greater than a threshold that is previously determined, and determines that the door is in a closed state when the determination value is less than or equal to the threshold; and
a loading rate estimation apparatus that estimates a loading rate of a vehicle equipped with the cargo compartment when the determination section determines that the door is in the closed state.
